(19) United States
(12) Patent Application Publication
(10) Pub. No.: US 2006/0168287 A1
(43) Pub. Date: Jul. 27, 2006

(54) Rotating event buffer

(76) Inventor: Timothy Holroyd Glauert, Cambridgeshire (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/005,735

(22) Filed: Dec. 7, 2004

(51) Int. Cl. G06F 15/16

(52) U.S. Cl. 709/231

(57) ABSTRACT

There is provided a system and method for ensuring relatively reliable transmission of data across a network connection from a client device to a server. The client device has a buffer in which new data items for transmission are stored on a FIFO basis. The method significantly reduces the chance of losing important data even when sending it over an unreliable connection. It does this without the cost. complexity and possible performance sacrifices of a fully-reliable transport protocol. In cases where limited memory is available on the processor of the client device, the method can be implemented even when memory is insufficient to store “reliable” transmission protocol code. The method is especially useful if the client is a relatively simple device, which has no other need for the processing power needed to implement TCP or other such protocols. In one example, the client device may be a terminal including a display and may wish to return keyboard and mouse data. The network may be wireless.

### FIELD OF THE INVENTION

The present invention relates to protocols for the transmission of data across digital networks, and more particularly to the transmission of data over unreliable packet-based networks.

### BACKGROUND OF THE INVENTION

One way of characterising the transmission of data over networks is by its reliability. In some systems, the network, that is to say the combination of hardware and software that provide transmission capabilities to an application, can be relied upon under normal conditions to deliver data to some remote location without any loss, corruption or re-ordering of the data on the way, except in the case of major failure.

Other systems work on a ‘best-effort’ basis. The network attempts to deliver the data, and in most cases succeeds (if the network is to be useful), but no guarantees are given. Sometimes all the data packets will arrive at the destination, though not in the order in which they were sent. Higher levels of software may be required to check that delivery has actually occurred, or to re-order the packets, if this is important for the application. Such networks are known as ‘unreliable’ networks. The term ‘unreliable’ does not indicate that the network is not useful, but rather that further steps must be taken if absolutely guaranteed delivery is required.

Creating a ‘reliable’ network often requires many layers of software: including software to deal with the various failure modes; sequence numbers to indicate the original ordering of data packets; checksums to confirm that the data has not been corrupted; timeouts which are triggered if the data fails to arrive in a timely fashion; and algorithms for deciding which data ought to be present and when. It is often the case, then, that unreliable networks are simpler and more efficient in applications where the occasional loss of-a packet is not a major handicap. A good example is in audio- or video-conferencing. A packet may contain a very short sample of speech, perhaps only a few milliseconds in duration, and it is often more important to keep these packets moving fast through the network with minimal latency than it is to ensure that every single sample arrives at the remote end.

A well-known example of this distinction can be found in the Internet Protocol (IP), a system which makes no assumption of reliability and simply provides a best-effort mechanism for getting packets from source to destination. Various layers are built on top of IP which implement different amounts of additional functionality, and two of the most common are the User Datagram Protocol (UDP) and the Transport Control Protocol (TCP). UDP provides very little extra functionality beyond the concept of ‘ports’, which are like the names of pigeonholes into which the data should be fed at the destination, and a checksum which allows the destination to check that the arriving data has not been corrupted. TCP, on the other hand, provides many extra facilities which ensure that a stream of data sent from the source arrives at the other end, with the data in the order in which it was sent, even when the underlying network is far from reliable. It provides for segmentation and reassembly of data, optimisation of segment size, handling of delayed acknowledgements, flow-control and a number of other features. Most transmission of email, web pages, and files on the internet uses TCP. Implementing the complexity of TCP on a very simple device can, however, be challenging.

### SUMMARY OF THE INVENTION

According to a first aspect of the present invention there is provided a method for ensuring transmission of data across a network connection from a client device to a server, the client device having a buffer, the method comprising:

storing a new data item for transmission in the buffer such that the new data item replaces a least recently stored data item in the buffer; and,

transmitting the data items stored in the buffer to the server across the network connection.

It is preferred that the transmission step includes the incorporation of the data items stored in the buffer within a corresponding network acknowledgement message. In this important embodiment, the transmission of buffer data forms part of an acknowledgement packet being sent back in response to data being sent by the server on a reliable connection. In the example of a terminal given above this may be display data. This allows an estimate of the reliability of the protocol since the rate at which acknowledgement packets are received by the server is known to be above some minimum level.

Preferably, the method further comprises: storing a pointer value; and, when each new data item is received, incrementing the pointer value to point to the new data item in the buffer. The buffer thereby additionally includes a pointer that indicates which data item is the most recently added.

The method may further comprise wrapping the buffer such that the data items stored in the buffer are stored in strict rotation. An epoch value may then be stored; and for each time the buffer wraps, the epoch value incremented, to indicate that each address in the buffer has been written to one more time. Thus the buffer includes an indication of the number of times the entire buffer has been rewritten.

The method of the present invention significantly reduces the chance of losing important data even when sending it over an unreliable connection. It does this without the cost, complexity and possible performance sacrifices of a fully-reliable transport protocol. In a typical embodiment of the invention, less than 40 bytes of code is required to implement a method for ensuring transmission of data. This compares favourably with a very efficient implementation of TCP for a comparable processor that takes over 3000 bytes of code. In many cases, the available memory on the processor used to implement the invention is insufficient to store this TCP code. While TCP provides additional functionality, it cannot be used in processors having limited available memory.

This method is especially useful if the client is a relatively simple device, which has no other need for the processing power needed to implement TCP or other such protocols. For example, the client may be a terminal including a display and may wish to return keyboard and mouse data. Recent developments in both display and network technology have meant that this terminal may rely almost entirely on the processing power of the server, but an effective implementation of this requires the server to receive input (eg keyboard and mouse) data from the terminal reliably. The method of the present invention provides means for achieving the desired level of reliability.

Advantageously, the new data item stored in the buffer originates in an external input device coupled to the client device.

According to another aspect of the invention, there is provided a system for ensuring transmission of data across a network connection, the system comprising: a server and a client device, wherein the client device has a buffer for storing a new data item for transmission, the buffer being operable to replace a least recently stored data item with the new data item; and a transmitter for transmitting the data items stored in the buffer to the server across the network connection.

Preferably, the transmitter may transmit data items stored in the buffer by incorporating the data items within a corresponding network acknowledgement message and transmitting the network acknowledgement message.

It is preferred that the client computer is further operable to store a pointer value in the buffer; and, when each new data item is received, to increment the pointer value to point to the new data item in the buffer.

Advantageously, the client computer may also be further operable to wrap the buffer such that the data items stored in the buffer are stored in strict rotation. In this case, the client computer may be further operable to store an epoch value; and, for each time the buffer wraps, to increment the epoch value, thereby indicating that each address in the buffer has been written to one more time.

It is preferred that the client computer further includes a receiver for receiving a new data item from an external input device coupled to the client device.

### BRIEF DESCRIPTION OF THE DRAWINGS

Examples of the present invention will now be described in detail with reference to the accompanying drawings, in which:

FIG. 1 illustrates a general purpose network; and

FIG. 2 is a schematic diagram of the operation of a buffer in accordance with the present invention.

### DETAILED DESCRIPTION

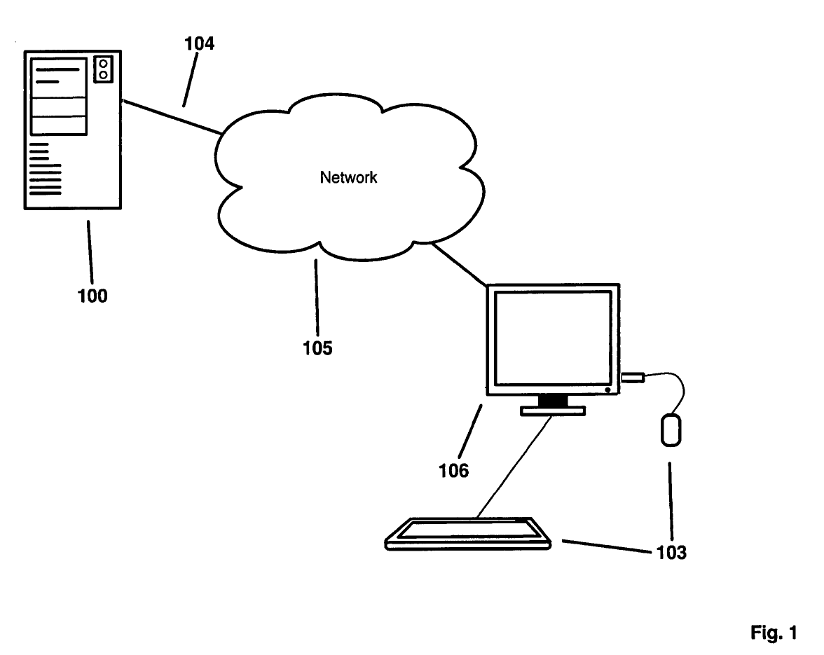

Referring to FIG. 1, a system in accordance with the present invention requires a remote network device (a client) 106 connected over a general purpose data network 105 to a server 100. The remote network device 106 may, as in the illustrated example, be a display on an ultra-thin terminal, and that device may wish to return event data, such as keyboard and mouse events 103, to the server 100. According to the present invention these events are placed in a buffer at the remote network device 106 and the top section of that buffer (that containing the most recent events) is sent back to the server 100. This typically involves the same data being transmitted to the server 100 a number of times, greatly increasing the chance that it will be received by the server 100. On some networks there is a minimum data packet size, or certain optimal packet sizes, so the cost of ending this extra data may be negligible or even zero. Standard ethernet packets, for example, must be 64 bytes or larger.

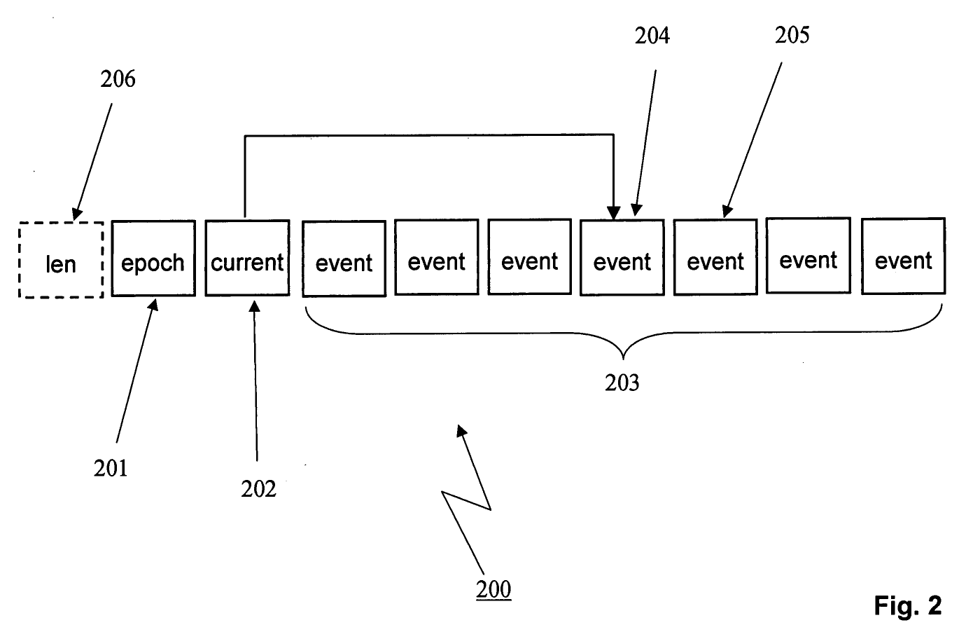

FIG. 2 shows a typical embodiment of the present invention. An event buffer 200, which will usually have a larger capacity for events than shown, contains a sequence of events 203. Events are written in the order in which they occur, and when the end of the buffer is reached it ‘wraps around’ (i.e. the next event is written to the first position in the event buffer). In this way, the first position in the event buffer is considered logically to follow the last, thus forming a continuous loop. A pointer 202 is provided that indicates where in the buffer the most recent event lies. In general, the buffer sent in two successive packets will be very similar and the pointer will indicate the most recent changes. For example if the pointer in one packet points at position 204, the next packet would typically have the latest event inserted at position 205 and the pointer updated to point at it.

By comparing the pointer with the last good one received, the server can deduce whether any messages, and hence any events, have been missed, and can process the missed events before the current one. It is also possible to compare earlier events with those in the previously received buffer as an extra consistency check. It is also possible to put several new events in a single packet, in which case the pointer will have moved on more than one position when the packet is sent. This makes no difference at the server, since all packets between the between the last received pointer position and the current one must still be processed.

The packet sent by the network device to the server preferably also includes an epoch value 201. This is a sequence number which increments each time the buffer wraps around. This allows the server to detect when a whole buffer's worth of packets or more have been lost, or when packets have arrived out of order. For example, if the pointer has not moved between two successive packets, but the epoch value 201 has increased, it can be deduced that a whole buffer load of events have been missed, and that the events between the pointer and the end of the buffer should be processed, followed by those from the beginning of the buffer to the pointer inclusive.

The following table shows how the various states might be interpreted on receipt of a packet. It describes the appropriate actions after comparing the current pointer and epoch value with those of the last known good packet received.

| | | Pointer change | | |
|---|---|---|---|---|
| | | Same | Bigger | Smaller |
| Epoch | Same | Dup. packet - | New events - | Out-of-order - |
| | | ignore | process | ignore |
| | Bigger | Process whole | Some events | New events - |
| | | buffer's worth | lost - recent | process |
| | | | available | wrapped buffer |

| | |
|---|---|
| Smaller | Lost or out-of-order packets - ignore |
| Zero | if epoch wrapped, treat as epoch ‘bigger’ |
| | else as epoch ‘smaller’ |

The event buffer may be any size. In particular it may be a fixed number of bytes, or may represent a fixed amount of time, or may vary over time based on such factors as the amount of packet loss on the network or the rate of events to be reported. It will be observed that, with a known maximum rate of packet loss on the network, and a known maximum event rate at the network device, the size of the buffer can be chosen to ensure that all events are delivered. In many situations the maximum event rate may be known, for example because a mouse reports movements at a certain fixed rate. Often the maximum rate of packet loss on the network may only be estimated, though this estimate may be reasonably accurate and based on the gathering of statistics or other analysis of the network itself

The event buffer optionally stores a buffer length value 206. The buffer length value specifies the number of bytes in the event buffer, thereby ensuring that the client device does not need to calculate an appropriate buffer size.

It is possible that a reliable or pseudo-reliable protocol is already in place to send data from the server to the network device. For example, if the network device includes a display, it may be important to ensure that the data shown on the display is entirely accurate, so the display data may be sent this way. Some reliable protocols make use of an acknowledgement packet which may be sent back from the device using an unreliable network connection. Since the connection is unreliable, these acknowledgements are not always received by the server. However, the server must receive enough acknowledgements to indicate data transmission is happening reliably, otherwise the protocol ceases to operate. In an important embodiment of the present invention the event buffer, pointer and epoch value are returned in this acknowledgment packet. In this case, it may be possible to guarantee completely reliable event delivery because the packets must get through at a certain rate if the entire system is to operate.

There is one situation which may need special attention in some implementations. If a single event is added to the buffer, and a packet is therefore sent to the server, but that packet is lost in transit, the server will not be aware of the event until the next packet is sent. Usually, the next packet is sent shortly afterwards because of further events or in response to data coming from the server. If, however, the unreliability of the network and the nature of the event data and network traffic is such that a single isolated event, if lost, must be recovered within a known period, it may be appropriate to resend the buffer at certain intervals until further network or event data is received. Again, in many circumstances, such a ‘keep-alive’ packet is useful to inform the server that the device is still active and connected.

1. A method for ensuring transmission of data across a network connection from a client device to a server, the client device having a buffer, the method comprising:
storing a new data item for transmission in the buffer such that the new data item replaces a least recently stored data item in the buffer; and,
transmitting the data items stored in the buffer to the server across the network connection.

2. A method as claimed in claim 1, wherein the transmission step includes:
incorporating the data items stored in the buffer within a corresponding network acknowledgement message.

3. A method as claimed in claim 1, further comprising:
storing a pointer value; and,
when each new data item is received, incrementing the pointer value to point to the new data item in the buffer.

4. A method as claimed in claim 1, further comprising:
wrapping the buffer such that the data items stored in the buffer are stored in strict rotation.

5. A method as claimed in claim 4, further comprising:
storing an epoch value; and
for each time the buffer wraps, incrementing the epoch value, thereby indicating that each address in the buffer has been written to one more time.

6. A method as claimed in claim 1, wherein the new data item stored in the buffer originates in an external input device coupled to the client device.

7. A system for ensuring transmission of data across a network connection, the system comprising:
a server; and a client device,
wherein the client device has a buffer for storing a new data item for transmission, the buffer being operable to replace a least recently stored data item with the new data item; and a transmitter for transmitting the data items stored in the buffer to the server across the network connection.

8. A system as claimed in claim 7, wherein the transmitter transmits data items stored in the buffer by incorporating the data items within a corresponding network acknowledgement message and transmitting the network acknowledgement message.

9. A system as claimed in claim 7, wherein the client computer is further operable to store a pointer value in the buffer; and, when each new data item is received, to increment the pointer value to point to the new data item in the buffer.

10. A system as claimed in claim 7, wherein the client computer is further operable to wrap the buffer such that the data items stored in the buffer are stored in strict rotation.

11. A system as claimed in claim 10, wherein the client computer is further operable to store an epoch value; and, for each time the buffer wraps, to increment the epoch value, thereby indicating that each address in the buffer has been written to one more time.

12. A system as claimed in claim 7, wherein the client computer further includes a receiver for receiving a new data item from an external input device coupled to the client device.
